(19) United States
(12) Patent Application Publication
(10) Pub. No.: US 2016/0333560 A1
(43) Pub. Date: Nov. 17, 2016

(54) Adhesive Lavatory Treatment Composition and Dispensing Article

(71) Applicant: RECKITT BENCKISER (BRANDS) LIMITED, Slough Berkshire (GB)

(72) Inventors: Leandro Pane GOULART, Sao Paulo (BR); Fabio Roberto MORA, Schiphol (NL)

(21) Appl. No.: 15/111,935

(22) PCT Filed: Jan. 8, 2015
(86) PCT No.: PCT/GB2015/050022

§ 371 Date: Jul. 15, 2016

(30) Foreign Application Priority Data
Jan. 30, 2014 (GB) 1401546.5

(51) Int. Cl. E03D 9/03; C11D 17/04; C11D 3/37; C11D 1/22; C11D 1/14; C11D 1/75; C11D 17/00; C11D 3/14

(52) U.S. Cl. CPC E03D 9/032; C11D 17/0056; C11D 17/041; C11D 3/14; C11D 1/22; C11D 1/143; C11D 1/75; C11D 3/3776; E03D 2009/024

(57) ABSTRACT

A combination package and dispensing article comprising an adhesive lavatory treatment composition which is adherable to a part of a lavatory appliance, e.g., the inner sidewall of a toilet bowl, wherein the combination package and dispensing article includes: a body of an adhesive lavatory treatment composition having at least one body has at least one generally planar side which adapts the body to be adhered to a generally flat or curved sidewall of a lavatory appliance, a separable backing part, and a blister having a body cavity, a domed or curved sidewall, a mounting handle extending outwardly from the body cavity, at least one edge standoff element, and at least one body standoff element, wherein the combination package and dispensing article is adapted to directly dispense the body onto the surface of a lavatory appliance or other hard surface without requiring that the consumer dispensing the said composition comes into direct contact with the said composition during any part of the dispensing process. Also disclosed are methods for the manufacture of the same, and methods for treating a lavatory appliance using the same.

The present invention relates to an adhesive lavatory treatment composition which is supplied to a consumer in a combination package and dispensing article, which facilitates the dispensing of the said composition from the package onto a part of a lavatory appliance, such as the sidewall of a toilet or urinal, without requiring that the consumer dispensing the said composition comes into direct contact with the said composition during any part of the dispensing process.

Known to the art are certain adhesive surfactant containing compositions which have demonstrated or which are alleged to have adhesive properties which make them suited to be placed on sloped, or vertical hard surfaces. The compositions of U.S. Pat. No. 6,667,286 may be adhered to wet or wetted hard surfaces, but require that a certain minimum amount of water be necessarily present in order to make these materials adherent. The example compositions disclosed therein comprise 3-60% wt. of water as a necessary constituent. Further adhesive compositions are known from EP 1978080 A1, and require an “adhesion promoter” constituent which comprises from 20-80% wt. of the compositions, and separately one or more surfactants selected from anionic, nonionic, cationic or amphoteric surfactants which provide “the detergent action of the composition”. From US 2009/0325839 are known adhesive surfactant containing compositions having a first surfactant constituent in an amount of at least 7.5% wt., and additionally also necessarily including a blend of linear primary alcohols or a blend of ethoxylated linear primary alcohols, which said compositions also must exhibit a specified minimum “transport rate factor”.

Known to consumers are commercial products used in the treatment of lavatory appliances, e.g., toilet bowls, bidets, urinals, presently sold by S.C. Johnson Co., which product includes a dispensing article which contains a quantity of an adhesive treatment composition, a small quantity or “dose” of which is dispensed. As the dispensing article includes a quantity of the adhesive treatment composition, it is used a number of times until the supply of the composition is spent. Between uses, the dispensing article must be stored by a consumer, and the dispensing end of which must be manually capped or covered by a consumer to ensure that the remaining adhesive treatment composition is not dried out or degraded prior to its next use. This requirement of capping between uses is very unfavorable from a consumer standpoint, as contact with the dispensing end of the dispensing article is generally to be avoided.

Thus while the prior art proposes certain compositions and devices which exhibit reasonably satisfactory performance under certain conditions, there nonetheless remains a real and continued need in the art for further improved lavatory treatment compositions which overcome shortcomings of prior art compositions.

In one aspect the present invention provides self-adhesive lavatory treatment compositions which are adapted to be directly adhered to a part of a lavatory appliance, e.g., the inner sidewall of a toilet bowl.

In a further aspect the present invention provides self-adhesive lavatory treatment compositions which are dispensed directly from a combination package and dispensing article, and directly adhered to a part of a lavatory appliance, e.g., the inner sidewall of a toilet bowl.

In another aspect, the present invention provides as a vendible article, a combination package and dispensing article containing a shaped mass (or body) of a adhesive lavatory treatment composition, from which article the said composition may be directly dispensed onto a surface of a lavatory appliance or other hard surface.

In a yet further aspect, the present invention provides a method for the manufacture of a combination package and dispensing article, containing a mass (or body) of a adhesive lavatory treatment composition, from which article the said composition may be directly dispensed onto a surface of a lavatory appliance or other hard surface.

In a still further aspect there is provided a method of treating a lavatory appliance utilizing an adhesive lavatory treatment composition which is dispensed directly from a combination package and dispensing article, and directly adhered to a part of the lavatory appliance, e.g., the inner sidewall of a toilet bowl.

These and further objects of the present invention will become apparent from a review of the following specification including the drawings.

The self-adhesive lavatory treatment compositions which are dispensed directly from a combination package and dispensing article, overcome many of the shortages of the prior art.

The combination package and dispensing article of the invention, (which may also be referred to as a “package/applicator”) comprises a formed body of a self-adhesive lavatory treatment composition, which is one preferred form of a vendible article.

The adhesive lavatory treatment compositions comprise:
at least 35% wt. of one or more detersive anionic surfactants;
0.01-10% wt. of one or more detersive nonionic and/or amphoteric surfactants;
0.001-5% wt. of at least one polyvinylpyrrolidone polymer constituent as an adhesion promoter constituent;
at least 35% wt. of one or more inert filler materials;
0-5% wt. water; and,
optionally, one or more further constituents which may impart a further aesthetic or technical benefit to the said self-adhesive lavatory treatment compositions.

The adhesive lavatory treatment compositions necessarily include one or more detersive anionic surfactants which comprise at least 35% wt., but preferably comprise at least about 40% wt. or more, of the said compositions. Advantageously the one or more detersive anionic surfactants do not comprise more than about 85% wt, preferably not more than about 75% wt. of the said compositions.

Exemplary useful detersive anionic surfactants include the water-soluble salts, particularly the alkali metal, ammonium and alkylolammonium (e.g., monoethanolammonium or triethanolammonium) salts, of organic sulfuric reaction products having in their molecular structure an alkyl group containing from about 10 to about 20 carbon atoms and a sulfonic acid or sulfuric acid ester group. (Included in the term “alkyl” is the alkyl portion of aryl groups.) Examples of this group of synthetic surfactants are the alkyl sulfates, especially those obtained by sulfating the higher alcohols (C₈-C₁₈ carbon atoms) such as those produced by reducing the glycerides of tallow or coconut oil; and the alkylbenzene sulfonates in which the alkyl group contains from about 9 to about 15 carbon atoms, in straight chain or branched chain. Such detersive anionic surfactants are linear straight chain alkylbenzene sulfonates in which the average number of carbon atoms in the alkyl group is from about 11 to 14.

Other exemplary useful detersive anionic surfactants herein are the water soluble salts of: paraffin sulfonates containing from about 8 to about 24 (preferably about 12 to 18) carbon atoms; alkyl glyceryl ether sulfonates, especially those ethers of C₈₋₁₈ alcohols (e.g., those derived from tallow and coconut oil); alkyl phenol ethylene oxide ether sulfates containing from about 1 to about 4 units of ethylene oxide per molecule and from about 8 to about 12 carbon atoms in the alkyl group; and alkyl ethylene oxide ether sulfates containing about 1 to about 4 units of ethylene oxide per molecule and from about 10 to about 20 carbon atoms in the alkyl group.

Other useful detersive anionic surfactants herein include the water soluble salts of esters of α-sulfonated fatty acids containing from about 0 to 20 carbon atoms in the fatty acid group and from about 1 to 10 carbon atoms in the ester group; water soluble salts of 2-acyloxy-alkane-1-sulfonic acids containing from about 2 to 9 carbon atoms in the acyl group and from about 9 to about 23 carbon atoms in the alkane moiety; water-soluble salts of olefin sulfonates containing from about 12 to 24 carbon atoms; and β-alkyloxy alkane sulfonates containing from about 1 to 3 carbon atoms in the alkyl group and from about 8 to 20 carbon atoms in the alkane moiety.

Preferred detersive anionic surfactants include anionic sulfate surfactants and anionic sulfonates surfactants. Exemplary anionic sulfate surfactants include the linear and branched primary and secondary alkyl sulfates, alkyl ethoxysulfates, fatty oleoyl glycerol sulfates, alkyl phenol ethylene oxide ether sulfates, the C₅-C₁₇ acyl-N—(C₁-C₄ alkyl) and —N—(C₁-C₂ hydroxyalkyl)glucamine sulfates, and sulfates of alkylpolysaccharides and mixtures thereof. Exemplary anionic sulfate surfactants include salts of C₅-C₂₀ linear alkylbenzene sulfonates, alkyl ester sulfonates, C₆-C₂₂ primary or secondary alkane sulfonates, C₆-C₂₄ olefin sulfonates, sulfonated polycarboxylic acids, alkyl glycerol sulfonates, fatty acyl glycerol sulfonates, fatty oleyl glycerol sulfonates, and mixtures thereof.

Preferred detersive anionic surfactants are disclosed with reference to one or more of the Examples.

The adhesive lavatory treatment compositions further necessarily include one or more detersive nonionic and/or amphoteric surfactants which comprise at least 0.01% wt., but preferably at least about 1% wt. or more, of the said compositions. Advantageously the one or more detersive nonionic and/or amphoteric surfactants do not comprise more than about 10% wt., more preferably not more than about 5% wt, and most preferably not more than about 3.5% wt. of the said compositions.

Exemplary useful detersive nonionic surfactants, include known art nonionic surfactant compounds. Practically any hydrophobic compound having a carboxy, hydroxy, amido, or amino group with a free hydrogen attached to the nitrogen can be condensed with ethylene oxide or with the polyhydration product thereof, polyethylene glycol, to form a water soluble nonionic surfactant compound. Further, the length of the polyethylenoxy hydrophobic and hydrophilic elements may vary. Exemplary nonionic compounds include the polyoxyethylene ethers of alkyl aromatic hydroxy compounds, e.g., alkylated polyoxyethylene phenols, polyoxyethylene ethers of long chain aliphatic alcohols, the polyoxyethylene ethers of hydrophobic propylene oxide polymers, alkoxylated alkylphenols, nonionic surfactant compounds based on a polymeric alkylene oxide block copolymer, alkyl polyglycosides, and the amine oxides, which are particularly preferred.

Preferred detersive nonionic and/or amphoteric compounds include amine oxide compounds which include:

A) alkyl di (lower alkyl) amine oxides in which the alkyl group has about 10-20, and preferably 12-16 carbon atoms, and can be straight or branched chain, saturated or unsaturated. The lower alkyl groups include between 1 and 7 carbon atoms. Examples include lauryl dimethyl amine oxide, myristyl dimethyl amine oxide, and those in which the alkyl group is a mixture of different amine oxide, dimethyl cocoamine oxide, dimethyl (hydrogenated tallow) amine oxide, and myristyl/palmityl dimethyl amine oxide;

B) alkyl di (hydroxy lower alkyl) amine oxides in which the alkyl group has about 10-20, and preferably 12-16 carbon atoms, and can be straight or branched chain, saturated or unsaturated. Examples are bis(2-hydroxyethyl) cocoamine oxide, bis(2-hydroxyethyl) tallowamine oxide; and bis(2-hydroxyethyl) stearylamine oxide;

C) alkylamidopropyl di(lower alkyl) amine oxides in which the alkyl group has about 10-20, and preferably 12-16 carbon atoms, and can be straight or branched chain, saturated or unsaturated. Examples are cocoamidopropyl dimethyl amine oxide and tallowamidopropyl dimethyl amine oxide; and

D) alkylmorpholine oxides in which the alkyl group has about 10-20, and preferably 12-16 carbon atoms, and can be straight or branched chain, saturated or unsaturated.

Preferred amine oxides are alkyl di-(lower alkyl) amine oxide as denoted above and which may be represented by the following structure:

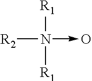

wherein each:

R₁ is a straight chained C₁-C₄ alkyl group, preferably both R₁ are methyl groups; and,

R₂ is a straight chained C₈-C₁₈ alkyl group, preferably is C₁₀-C₁₄ alkyl group, most preferably is a C₁₂ alkyl group.

Each of the alkyl groups may be linear or branched, but most preferably are linear. Technical grade mixtures of two or more amine oxides may be used, wherein amine oxides of varying chains of the R₂ group are present. Preferably, the amine oxides used in the present invention include R₂ groups which comprise at least 50% wt., preferably at least 60% wt. of C₁₂ alkyl groups and at least 25% wt. of C₁₄ alkyl groups, with not more than 15% wt. of C₁₆, C₁₈ or higher alkyl groups as the R₂ group.

While amine oxides are often considered as being nonionic surfactants, it is to be recognized that at certain pHs, that amine oxide compounds behave as amphoteric surfactants and may be considered to be amphoteric surfactants when they are present in the compositions of the invention which have a pH in the range of from 7-13 and preferably wherein the pH is in the range of 9-12.

Particularly preferred detersive nonionic and/or amphoteric surfactants, and especially preferred amine oxide surfactants are disclosed with reference to the Examples.

A further essential constituent of the invention is at least one polyvinylpyrrolidone polymer constituent which may be a polyvinylpyrrolidone or polyvinylpyrrolidone copolymer containing polyvinylpyrrolidone monomers. The inventors have surprisingly found that even a minor amount of a polyvinylpyrrolidone polymer constituent, viz., approx. 5% wt. or less, improves the surface adhesion properties of the compositions.

Exemplary useful polyvinylpyrrolidone homopolymers are generally provided as a technical grade mixture of polyvinylpyrrolidone polymers within approximate molecular weight ranges. Exemplary useful polyvinylpyrrolidone polymers are available in the PVP line materials (ex. ISP Corp.) which include PVP K 15 polyvinylpyrrolidone described as having molecular weight in the range of from 6,000-15,000; PVP-K 30 polyvinylpyrrolidone with a molecular weight in the range of 40,000-80,000; PVP-K 60 polyvinylpyrrolidone with a molecular weight in the range of 240,000-450,000; PVP-K 90 polyvinylpyrrolidone with a molecular weight in the range of 900,000-1,500,000; PVP-K 120 polyvinylpyrrolidone with a molecular weight in the range of 2,000,000-3,000,000. Preferred polyvinylpyrrolidone polymers are described with reference to the Examples.

Exemplary useful polyvinylpyrrolidone copolymers which comprise polyvinylpyrrolidone monomers with further monomers such as acetates including vinylacetates, vinylcaprolactams, as well as ammonium containing monomers, such as ammonium containing terpolymers. Non-limiting examples of vinylpyrrolidone/vinylacetate copolymers which find use in the adhesive compositions include vinylpyrrolidone/vinylacetate copolymers, examples of which are presently commercially available. Such vinylpyrrolidone/vinylacetate copolymers are comprised of vinylpyrrolidone monomers which may be represented by the following structural formula:

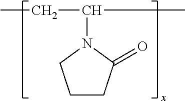

and vinylacetate monomers which may be represented by the following structural formula:

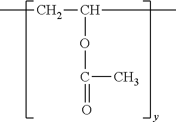

which are usually formed by a free-radical polymerization reaction to produce linear random vinylpyrrolidone/vinyl acetate copolymers. The resultant vinylpyrrolidone/vinylacetate copolymers may comprise varying amounts of the individual vinylpyrrolidone monomers and vinylacetate monomers, generally with the ratios of vinylpyrrolidone monomers vinylacetate monomers from 30:70 to 70:30. IN the foregoing structures, the values of x and y in the structural formula advantageously have values such that x+y=100 to 1500. Such values correspond to provide vinylpyrrolidone/vinylacetate copolymers having a total molecular weight in the range of at least from about 10,000 to generally not in excess of about 250,000.

Non-limiting examples of vinylpyrrolidone/vinylcaprolactam/ammonium derivative terpolymers are comprised of vinylpyrrolidone monomers which may be represented by the following structural formula:

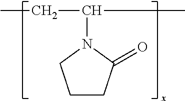

and vinylcaprolactam monomers which may be represented by the following structural formula:

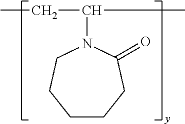

and dimethylaminoethylmethacrylate monomers which may be represented by the following structural formula:

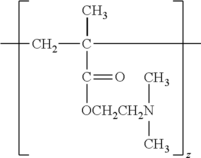

Exemplary vinylpyrrolidone/vinylcaprolactam/ammonium derivative terpolymer wherein the ammonium derivative monomer has 6 to 12 carbon atoms and is selected from diallylamino alkyl methacrylamides, dialkyl dialkenyl ammonium halides, and a dialkylamino alkyl methacrylate or acrylate which find use in the present inventive compositions include those marketed under the tradename ADVANTAGE® (ex. ISP) as well as GAFFIX® (ex. ISP Corp). Such terpolymers are usually formed by a free-radical polymerization reaction to produce linear random vinylpyrrolidone/vinylcaprolactam/ammonium derivative terpolymers. Advantageously the vinylpyrrolidone/vinyl caprolactam/ammonium derivative terpolymers comprise 17-32 weight % vinylpyrrolidone; 65-80 weight % vinylcaprolactam; 3-6 weight % ammonium derivative and 0-5 weight % stearyl methacrylate monomers. The polymers can be in the form of random, block or alternating structure having number average molecular weights ranging between about 20,000 and about 700,000; preferably between about 25,000 and about 500,000. The ammonium derivative monomer preferably has from 6 to 12 carbon atoms and is selected from the group consisting of dialkylaminoalkyl methacrylamide, dialkyl dialkenyl ammonium halide and a dialkylamino alkyl methacrylate or acrylate. Examples of the ammonium derivative monomer include, for example, dimethylamino propyl methacrylamide, dimethyl diallyl ammonium chloride, and dimethylamino ethyl methacrylate (DMAEMA). These terpolymers are more fully described in U.S. Pat. No. 4,521,404 to GAF Corporation, the contents of which are hereby incorporated by reference.

Of the foregoing, polyvinylpyrrolidone homopolymers are generally preferred.

The at least one polyvinylpyrrolidone polymer constituent may be present in any amount which is found to be effective in increasing the adhesivity of the adhesive lavatory treatment compositions to hard surfaces, an in particular to glazed or ceramic hard surfaces such as are found in lavatory appliances (e.g., toilets, bidets, urinals) as compared to a like composition wherein the said one polyvinylpyrrolidone polymer constituent is omitted. Advantageously such an amount can be as little as 0.001% wt. to 5% wt., of the total weight of the adhesive lavatory treatment composition of which it forms a part. A preferred range is 0.01-2.5% wt., more preferably 0.1-1% wt., especially preferably 0.2-0.7%, and particularly preferably, one or more of the amounts demonstrated in the example compositions.

The adhesive lavatory treatment composition necessarily also includes at least 35% wt. of one or more inert inorganic or organic filler materials. Preferably such are provided as comminuted or particulate materials. These inert filler materials may be compounds or materials which are preferably insoluble in water and/or in organic solvents. Non-limiting examples of such inert fillers include silicates such as sodium silicate and aluminum silicate, chemically modified magnesium aluminum silicate, hydrated aluminum silicate, fumed silica, silica dioxide, talc (layered magnesium silicate), chalk, carbonates including alkali metal carbonates such as sodium or potassium carbonates and bicarbonates, kaolin, carbon black, insoluble sulfates such as sodium sulfate, and mixtures thereof The inert filler constituent comprises at least 35% wt., preferably at least 40% wt. of the adhesive lavatory treatment compositions, but advantageously does not exceed about 75% wt. A preferred range for the inert filler material(s) is from 40-60% wt. of the adhesive lavatory treatment composition of which it forms a part.

Where it is desired to produce an adhesive lavatory treatment composition which is transparent or translucent, preferably the one or more inert inorganic or organic fillers are particulate materials which are of a particle size that they are not readily perceived by a user. Advantageously such filler materials have an average particle of size less than 300 microns, more preferably less than 100 microns and most preferably less than 50 microns. Preferably, particulate insoluble particles have a maximum particle size of 300 microns or less, preferably 200 microns or less.

Water, if present, forms only a minor amount of the adhesive lavatory treatment compositions. In a preferred embodiment, no water is added as a constituent, and the only water present in the composition is that provided as either ambient atmospheric moisture, or when present as a carrier or part of another constituent. Where no water is added as a separate constituent, and the only water supplied as from the ambient atmosphere or via a carrier or part of another constituent, such is considered to contain 0% water for the purposes of this invention. If water is added as a constituent, it is generally only added as a separate constituent in minor amounts, and it forms not more than 5% wt, and preferably not more than 3% wt. of the adhesive lavatory treatment composition of which it forms a part. Preferably no water is added as a separate constituent of the composition. Preferably where no water is added as a separate composition, the sole water present is that provided from the absorption of humidity from the ambient air, or from water supplied via a different constituent, then the total amount of water is not more than about 5% wt., preferably not more than about 3% wt. However, when added as a separate constituent, such added water is desirably distilled, deionized or demineralized water.

The adhesive lavatory treatment composition may comprise one or more further optional constituents which may impart a further aesthetic or technical benefit to the said self-adhesive lavatory treatment compositions. When present, such further optional constituents are generally present in a cumulative amount of less than about 25% wt. based on the total weight of the adhesive lavatory treatment composition. By way of non-limiting example such further optional constituents include one or more of: further surfactant compounds not already disclosed as being amongst the essential constituents, coloring agents, fragrances and fragrance solubilizers, viscosity modifying agents, thickeners, bleaches, bleach releasing compounds, oxidizing agents, germicidal agents, pH adjusting agents and pH buffers including organic and inorganic salts as well as organic and inorganic acids, builders, chelating agents, opacifying agents, titanium dioxide, hydrotropes, enzymes as well as other biologically active constituents, anti-oxidants, preservatives, and anti-corrosion agents, as well as other optional constituents known to the skilled artisan. When one or more of the optional constituents is added, i.e., fragrance and/or coloring agents, the esthetic and consumer appeal of the product is often favorably improved.

The use and selection of these optional constituents should be based on imparting a desired additional aesthetic or technical benefit, as well as to ensure compatibility with the further constituents present in the adhesive lavatory treatment compositions, especially such that the desirable adhesive properties of the compositions are not deleteriously diminished.

Examples of further additional surfactant compounds include one or more of: cationic surfactants such as quaternary ammonium compounds, amphoteric surfactants such as alkylbetaines, amidoalkylbetaines, sultaines, as well as further surfactants such as sarcosinates, e.g., cocoyl sarcosinate, lauroyl sarcosinate. When present such are preferably included in amounts of from about 0.01-25% wt.

Examples of germicidal agents include one or more of: halophenols such 3-trifluoromethyl-4,4′-dichlorocarbanilide, 3,3′,4-trichlorocarbanilide, as well as 2,4-dichloro-3,5-m-xylenol (“DCMX”), parachlorometacresol (“PCMC”), parachlorometaxylenol (“PCMX”), one or more phenol derivatives such as those based on 2-hydroxydiphenyl compounds, including Triclosan® (ex. Ciba), those based on 2,2′-hydroxy-5,5′-dibromo-diphenyl ethers, such as one or more of chlorophenols (o-, m-, p-), such as “Triclocarban”, 3,4,4′-trichlorocarbanilide as well as derivatives thereof. The optional germicide constituent may also be based on one or more acids, including organic acids such as salicylic and citric acid, and/or inorganic acid such as hydrochloric acid when present in effective amounts in order to sufficiently acidify the treatment composition formed from the water being periodically contacted with (e.g, flushed over) the adhesive lavatory treatment composition. When present such are preferably included in amounts of from about 0.00001-2% wt.

Examples of coloring agents include pigments and dyestuffs. Such coloring agents may be provided in a liquid carrier composition, such water or an organic solvent, or in a mixture of both. When present such coloring agents are advantageously included in effective amounts. When present such are preferably included in amounts of from about 0.00001-2% wt.

Fragrances are advantageously included as such may impart an attractive or user desirable fragrance to both the composition and the environment of the lavatory appliance to which the adhesive lavatory treatment composition is adhered. Fragrances may derived from natural materials, and/or be synthetically produced, and mixture of individual fragrance compounds are frequently used. Such fragrance compounds are usually provided in a liquid carrier composition, such water or an organic solvent, or in a mixture of both. When present such fragrances are advantageously included in effective amounts to impart a user perceptible fragrance effect and/or to reduce malodors. When present such are preferably included in amounts of from about 0.0000001-2.5% wt.

The adhesive lavatory treatment compositions form self-supporting bodies, which do not appreciably sag or run when initially adhered to a surface, viz, a hard surface upon which they are used.

The adhesive lavatory treatment compositions may be formed by mixing of one or more of the constituents, at room temperature or at an elevated temperature. Where certain of the constituents are solid, pasty, waxy or viscous at room temperature it may be advantageous to heat such constituents until they are liquefied or flowable, before or during there mixing with or addition to other constituents.

A preferred process for producing the adhesive lavatory treatment compositions may be described as follows:

The solid constituents are provided into the feed hopper of an extruder (single screw, or twin screw) and the extruder is operated. The liquid constituents are added to the feed hopper as well, or optionally are provided at one or more downstream ports downstream of the extruder feed hopper and prior to the outlet. The extruder is optionally heated but such is not necessary in all instances as the frictional and shear forces generated within the extruder barrel may be sufficient to fluidify one or more of the constituents supplied. It is only required that the extruder ensures that the constituents are homogenously blended before being forced out an exit die, wherein the extrudate forms a bar which is cut into individual block or preforms. Preferably a cutting means, such as a knife or chain cutter is present downstream of the exit die such that the individual blocks or performs are cut into unit amounts while the extrudate has not cooled fully to room temperature (20° C.).

In an alternative preferred process to the above, the solid constituents are first mixed, combined or blended to form a first premixture, and the liquid constituents are separately mixed, combined or blended to form a second premixture and subsequently measured amounts of each premixture are supplied to the inlet, e.g., feed hopper or inlet port of an extruder, and subsequently processed as set forth above.

The individual blocks or performs which had been cut into unit amounts are useful shaped bodies which may be used to treat a lavatory appliance without further processing steps if desired.

The individual blocks or performs which had been cut into unit amounts and are useful as shaped bodies are subsequently introduced into a provided to the cavity of the blister part of a combination package and dispensing article, or package/applicator, and thereafter a backing part may be adhered to the margins of the blister part, thereby sealing the shaped body within the cavity. Preferred combination packages are depicted and described with reference to one or more of the drawing figures.

Optionally, thereafter the cut unit amounts of the individual blocks or preforms are then optionally supplied to a compression apparatus and into a die cavity which advantageously has two parts. The individual blocks or performs are compressed within the die cavity to assume the final form of the shaped body of the adhesive lavatory treatment composition. In this process the density of the individual blocks or performs is preferably increased by at least 0.5%, and in order of increasing preference, at least: 0.75%, 1%, 1.25%, 1.5%, 1.75%, 2%, 2.25% and 2.5% as compared to the density of the extrudate or performs prior to compression and shaping within the die cavity. Thereafter, the thus resultant shaped compressed body is removed, and provided to the cavity of the blister part of a combination package and dispensing article, or package/applicator, and thereafter a backing part may be adhered to the margins of the blister part, thereby sealing the shaped body within the cavity.

It is also to be understood that any other device which may be used to provide a preform, other than an extrudate as described herein, may also be used.

The shaped mass or body of the adhesive lavatory treatment compositions may also be formed by supplying an aliquot of the composition into one or more cavities of a blister which forms part of the combination package and dispensing article of the invention, wherein it assumes the shape of at least part of the blister. Such may occur for example where the adhesive lavatory treatment composition is supplied in a flowable or fluid form to the cavity of the blister, and after a quantity is supplied the quantity hardens to assume the shape of the blister (or part of the blister) which it contacts. Such may occur, e.g., wherein the adhesive lavatory treatment composition is heated to a flowable or fluid form thereof, and after being delivered to the blister, the adhesive lavatory treatment composition cools to become pasty, or more rigid than the flowable or fluid form thereof in which it was supplied.

The shape of the shaped body of the adhesive lavatory treatment compositions may be virtually any shape. By way of non-limiting example it may be any regular or irregular geometric body, e.g, a hemisphere, an ovoid, or may be in the shape of an abstract body, or it may assume or suggest the shape of a recognizable article, e.g, a star, a flower, and the like. The shaped body may be symmetrical or non-symmetrical. The shape of the body of the adhesive lavatory treatment compositions may assume a ‘reverse mold’ characteristic and assume the complimentary shape of the cavity of the blister in which the adhesive lavatory treatment is provided.

The shaped mass or body of the adhesive lavatory treatment compositions may be formed into three-dimensional masses (or bodies) separately from the blister into which they are ultimately provided. For example, aliquots of the adhesive lavatory treatment composition may be supplied in a flowable or fluid form to one or more suitably shaped cavity molds, therein assume or become more viscous or harden such that they may retain the shape of the cavity mold after being ejected therefrom and are formed bodies, and these one or more formed bodies of the adhesive lavatory treatment compositions may be supplied to a blister part of a combination package and dispensing article of the invention, or alternately the package/applicator.

Preferred adhesive lavatory treatment compositions of the invention are viscous or pasty, and may be characterized in having a viscosity in the range of from about 150,000 cP to about 7,000,000 cP, but preferably measured at a temperature of 20° The viscosity may be determined utilizing conventional analytical instruments.

The adhesive lavatory treatment compositions are formed into a shaped mass or shaped bodies, preferably according to any of the foregoing described processes. The resultant shaped mass or shaped body preferably has a volume of from about 5 to about 15 cubic centimeters (cm³). Preferably from about 6 to about 12 cubic centimeters. Preferably the shaped body has a mass of between about 2 and about 25 grams, preferably 5-20 grams, and more preferably 10-15 grams. Further preferably the body has at least one generally planar side which adapts the body to be adhered to a generally flat or curved sidewall of a lavatory appliance, e.g., the interior sidewall of a toilet bowl, bidet or urinal. Preferably the at least one generally planar side has a surface area of approximately about 1 to about 35 cm², preferably about 5-25 cm², and more preferably about 15-20 cm².

The body of the adhesive lavatory treatment compositions may be applied to hard surfaces, preferably enameled, surfaces, or glazed or unglazed ceramic surfaces as well, e.g, in a shower stall, if desired. The body is most desirably directly applied to the hard surface directly from the combination package and dispensing article of the invention, or, alternately the package/applicator, without requiring that the adhesive lavatory treatment compositions be directly touched or contacted by the user (person) applying the body. The body is applied in the flow path of flowing water, e.g, flush water, which impinges upon the adhered self-adhesive lavatory treatment compositions and slowly erodes the same, and thereby forming a lavatory treatment liquid which comprises the water which entrains one or more of the constituents of the self-adhesive lavatory treatment compositions which has been released by the water. Once applied, the body of the adhesive lavatory treatment compositions may be flushed away after a plurality of flushing operations, preferably following a relatively large number of flushing operations. Although the operating parameters of lavatory devices, e.g., toilets, vary considerably and that the range of compositions are also variable, preferably, once applied a body of the adhesive lavatory treatment composition is at least in part retained in the hard surface for at least 5, and in order of increasing preference, at least 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 179, 175, 180, 185, 190, 195, 200, 205, 210, 215, 220, 225, 230, 235, 240, 240 and 250 flushes, or until the mass of the self-adhesive lavatory treatment compositions is eroded by the flushing water of the lavatory device. In preferred embodiments the adhesive lavatory treatment composition is at least in part retained in the hard surface for at least 120 flushes, preferably at least 150 flushes, more preferably at least 180 flushes, or more.

Thus, an aspect of the invention provides a method for treating a lavatory appliance comprising the steps of: applying an self-adhesive lavatory treatment composition directly to a part of a lavatory appliance wherein the adhered self-adhesive lavatory treatment composition is in the path of flowing water, e.g., flush water, and, operating the lavatory appliance to dispense a flow of water which impinges on the self-adhesive lavatory treatment composition in the path of flowing water which contacts and slowly erodes the lavatory treatment composition, thereby forming a lavatory treatment liquid which treats the lavatory appliance. This lavatory treatment liquid comprises water, and one or more of the constituents which are eluted into the flush water from the self-adhesive lavatory treatment composition.

The adhesive lavatory treatment compositions are most preferably supplied in a combination package and dispensing article, viz., “package/applicator”, which facilitates the dispensing of the said composition from the package onto a part of a lavatory appliance, such as the sidewall of a toilet or urinal, without requiring that the consumer dispensing the said composition comes into direct contact with the said composition during any part of the dispensing process. A preferred configuration of this combination package and dispensing article is described in more detail below and is depicted in the drawing figures.

The combination package and dispensing article, or package/applicator, comprises at least a blister part, having a cavity configured to contain one or more doses or shaped body/bodies of the adhesive lavatory treatment compositions and a separable backing part, which is adhered to the margins of the blister part, but is separable therefrom. The blister part may be of any material which can be suitably formed, but advantageously is formed from a thermoplastic material, such as a thermoplastic polymer which can be injection molded, but preferably is vacuum draw molded to the ultimate configuration of the blister part. By way of nonlimiting example, polymers such as polyolefins and polyalkylene terephthalates may be used, as well as further non-polymer materials including metallic foils. The material of construction of the blister part can also be a laminated material, having two or more layers of discrete materials of different chemical or physical compositions. The backing part can be any material which can be adhered, or otherwise applied in a removable manner to the blister part, preferably to a peripheral margin of the blister part. By way of nonlimiting example, the backing part can be a generally rigid material such as a coated paper, a coated card, a plate, a film, or a foil but advantageously is a flexible film formed of a foil, metallized polymer, or polymer sheet which can be peeled away from the blister part immediately prior to the application of the body to a surface.

The shaped bodies (shaped blocks, or blocks) formed from the adhesive lavatory treatment compositions require no mechanical suspending devices, such as embedded or adhered hooks or hangers, nor do the shaped bodies require that they be placed in the cage or container of a in the bowl treatment device wherein they are contained, separated from the sidewall of the lavatory appliance, e.g., toilet bowl, and through which cage or container flush water enters and exits during a flush cycle of the lavatory appliance. Rather the said shaped bodies require only direct adhesion to a part of a lavatory appliance, e.g, the inner surface of a lavatory appliance which is periodically wetted with a largely aqueous composition, e.g., flush water, during a flush or rinse operation of the lavatory appliance.

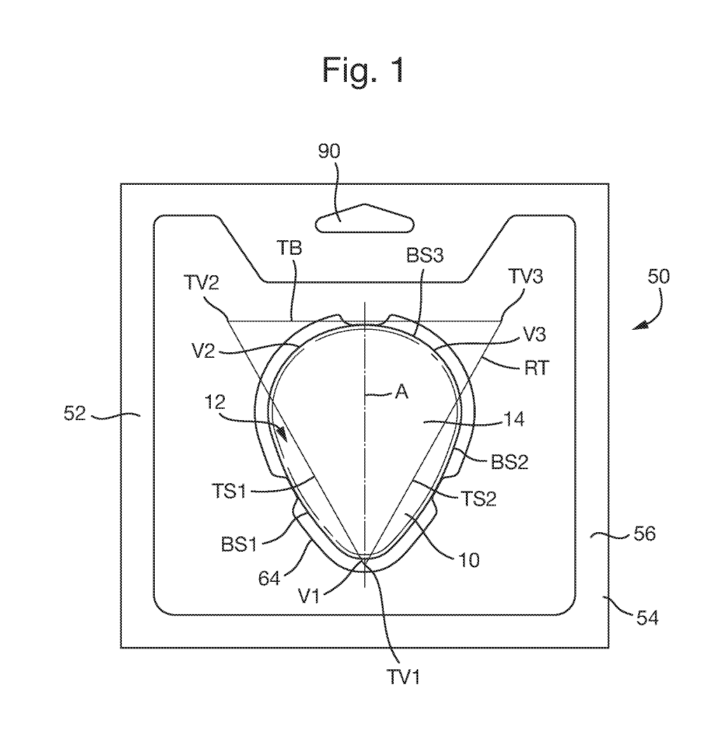

Reference is now made to the drawing figures. As may be seen therefrom, particularly from FIG. 1 there is depicted a body 10 present within an interior of a blister part 52 of the combination package and dispensing article 50, alternately named the “package/applicator” 50. In this preferred embodiment, the body 10 was generally in the shape of an oblate equilateral triangle which when viewed from its underside 12, defined here as the generally planar face 14, is generally symmetrical about its vertical axis “A”. For purposes of reference, on FIG. 1 is illustrated the underside 12 of a body 10 of an adhesive lavatory treatment composition formed from a composition of Table 1, upon which is overlaid a “reference equilateral triangle” “RT”, having two equal sides “TS1”, “TS2”, and a base “TB” bisected by the vertical axis “A”. The three oblate vertices, V1, V2 and V3 of the body 10 are also illustrated with reference to the corresponding vertices TV1, TV2 and TV3 of the reference triangle RT. As is visible, the body 10 has two curved sides BS1 and BS2 of generally equal dimensions, respectively between V1 and V2, and V1 and V3, and respectively corresponding with TS1 and TS2, and the third base curved side BS3 between V2 and V3, and corresponding to TB.

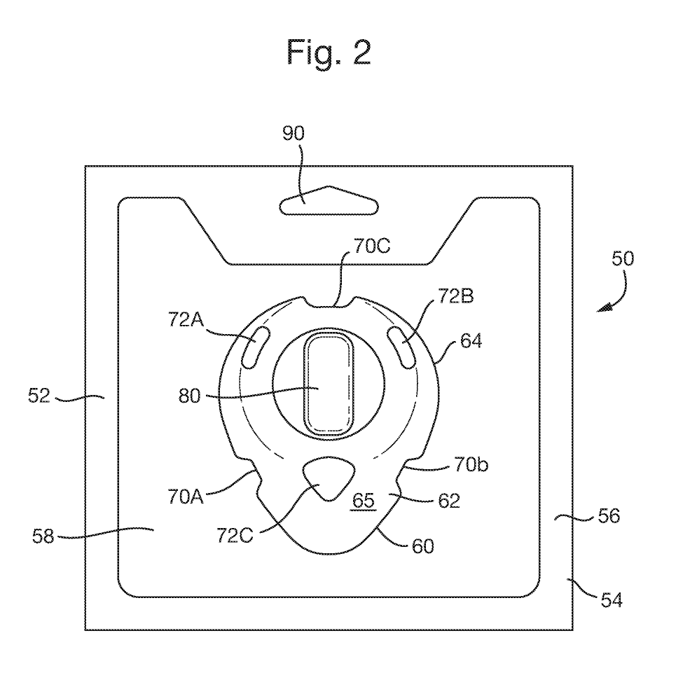

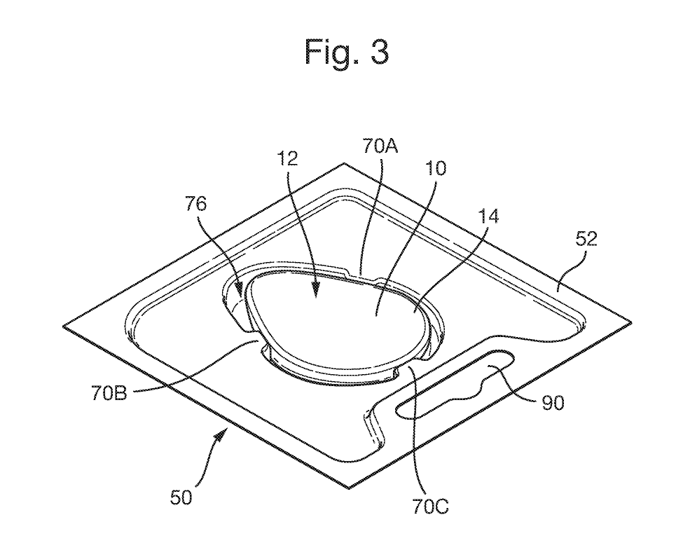

With reference now to both FIG. 1 and FIG. 2, the latter depicts the interior of the blister part 52 of FIG. 1, absent the body 10 of the adhesive lavatory treatment composition. As is visible from both figures, the blister part 52 includes a margin region 54 which extends around the entire periphery of the blister part 52, having a generally planar face 56 which is adapted to be laminated to, or applied against the backing part (not shown). Within the interior of this margin region 54 is a first recessed cavity part 58 which extends toward the body cavity 60 which is approximately in the center of the blister part 52, and concave with respect to the first recessed cavity part 58. The configuration of the body cavity 60 is one which is adapted to receive the body 10 of the adhesive lavatory treatment composition and provide a receptacle therefore. The body cavity 60 includes a generally domed or curved sidewall 62 which meets the first recessed cavity part 58 at a body cavity edge 64. Extending inwardly but at least in part coincident with the plane of the first recessed cavity part 58 are a plurality of edge standoff elements 70A, 70B and 70C which extend towards the interior of the body cavity 60. These edge standoff elements 70A, 70B and 70C are configured with respect to the blister part 52 and the body 10 part, so to retain the underside 12 of the body 10 therebetween, with a first edge standoff element 70A adjacent to or abutting the curved side BS1, the second edge standoff element 70 adjacent to or abutting the curved side BS2, and the third edge standoff element 70C adjacent to or abutting the curved base side BS3 of the body 10. When the blister part 52 is suspended from a hanging hook, such as via the (optional) perforation 90 passing through the blister part 52 and/or the backing part (not shown), and displayed as a vendible product, the vertex V1 of the body 10 is directed downwardly. Further present and extending outwardly from the body cavity 60 are a plurality of body standoff elements 72A, 72B and 72C which extend into the interior 65 of the body cavity 60 and depend from the sidewall 62. Similarly these body standoff elements 72A, 72B and 72C are configured or dimensioned such that they contact or are adjacent to the surface of the body 10. As is seen the body standoff element 72A is located between edge standoff element 70A and 70C, body standoff element 72B is located between edge standoff element 70B and 70C, and body standoff element 72C is located between edge standoff elements 70A and 70B. Each of the edge standoff elements 70A, 70B and 70C and each of the body standoff elements 72A, 72B and 72C operate to provide an air gap region 76, or non-contact surface between the body 10 and the generally domed or curved sidewall 62 of the body cavity 60, as is more clearly seen in the perspective view of FIG. 3. As is seen thereon, when in such a “face down” position, the body 10 only contacts the adjacent parts of the edge standoff elements 70A, 70B and 70C and while not visible, it is to be understood that the body 10 also only contacts the body standoff elements 72A, 72B and 72C. Preferably the maximum percentage of the surface area of the body 10 which is or which may come into physical contact with one or more of the edge standoff elements 70A, 70B and 70C and the body standoff elements 72A, 72B and 72C is 7%, but is preferably even lesser, preferably not more than 5%, and more preferably is not more than 3%.

The dimensions of the body 10 are such that the underside 12 of the body 10 may extend beyond the generally planar face 56 of the margin region 54 of the blister part 52, so that it extends outwardly from the body cavity. Prior to use, the underside 12 of the body 10 may come in contact with the backing part (not shown). Preferably however, when the backing part is detached from the blister part 52, e.g, by being peeled away, then the underside 12 is exposed and may be brought into direct contact with a part of a lavatory appliance.

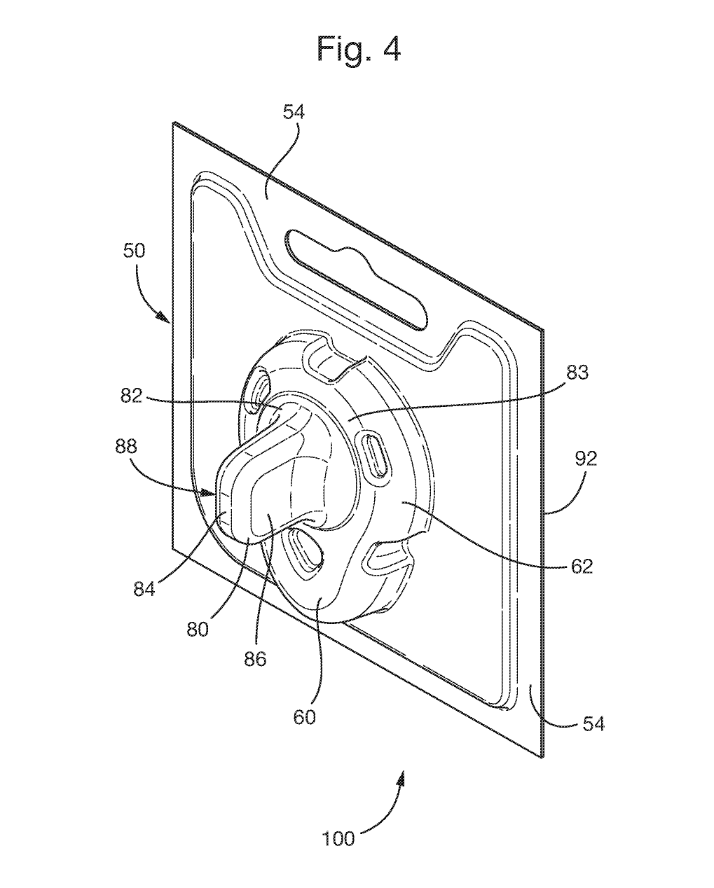

Further, in the depicted embodiment the blister part 52 of the package/applicator 50 further includes a mounting handle 80 which is formed to extend outwardly from the body cavity 60 in a direction away from (and generally approximately perpendicular to) the first recessed cavity part 58. Its configuration is depicted on FIGS. 2 and 4, in which figure is also seen the backing part, here a peelable polymer film 92 which is adhered to the margin region 54 but is not adhered elsewhere to the blister part 10. As is visible, the handle part 80 has a base 82 which is either coincident with or which extends from the generally domed or curved sidewall 62 and may be dependent therefrom, and at an opposite end, a terminal end 84. To facilitate gripping by a user, such as between two fingers of a hand, the handle part has two spaced apart generally flat faces 86, 88 between the base 82 and terminal end 84. It is to be understood that a body 10 of adhesive lavatory treatment composition is present in the interior of the body cavity 60 of the combination package and dispensing article 100.

The base 82 of the handle part 80 includes a compression part 83 which in this embodiment is generally circular, but in any configuration is a part of the base 82 which comes into direct physical contact with the body 10 when the handle part 80 is urged towards the body. The surface area of the compression part 82 which actually comes into such physical contact with the body 10 is not more than 40%, and in order of increasing preference is not more than: 35%, 30%, 28%, 26%, 25%, 24%, 22%, 20%, 19%, 18%, 17%, 16%, 15%, 14%, 13%, 12%, 11%, 10%, 9%, 8%, 7%, 6%, 5%, 4%, 3%, 2%, and 1% or less than the planar area defined by the generally planar face 14 of the body 10 which is adapted to be to be adhered to a generally flat or curved sidewall of a lavatory appliance. In such an arrangement, the interfacial contact between the compression part 83 and the surface of the block 10 may be controlled or minimized, in comparison to the surface area of the planar face 14 which is ultimately adhered to the lavatory dispensing device, preferably the inner sidewall of a toilet bowl.

In use a consumer or user may peel away the film 92, which exposes the underside 12 of the body 10, which is generally parallel to the plane of the a first recessed cavity part 58, which in turn is recessed from the plane of the margin 54. Such establishes a gap or distance, such that when the blister part 50 is placed against a flat face in an unstressed condition, the underside 12 is spaced away therefrom. Only upon the manual compression by a user gripping the mounting handle 80 and urging it in the direction of the adjacent surface (which may also be a surface of a lavatory appliance, especially the interior of a toilet bowl, of a urinal or of a bidet) is the body 10 urged to come into contact with the surface, and becomes adhered thereto, preferably by direct interfacial contact with the surface and the generally planar face 14 of the block 10. Thereafter the mounting handle 80 may be withdrawn, and the blister part 50 is concurrently also withdrawn.

### EXAMPLE

Example composition(s) of adhesive lavatory treatment compositions according to the invention was/were produced, and is/are identified on Table 1. The composition(s) disclosed on Table 1 demonstrate compositions according to the invention, including certain preferred embodiments of the invention. In these compositions, the constituents were used “as supplied” from their respective suppliers. The constituents may be less than 100% wt. “actives”, or may have been supplied as being 100% wt. “active” of the named compound, as indicated in the following Tables 1 and Table 2. The identified amounts of each constituent on Table 1 are in “% wt.” based on the total weight of a composition of which it forms a part. No added water was supplied to or formed part of the example compositions.

The example composition disclosed as E1 was formed generally in accordance with the following steps:

The pulvurent raw materials at room temperature (20° C.) were first provided to a first mixer wherein they were mixed to form a homogenous pulvurent premixture. Separately the liquid raw materials at room temperature (20° C.) were combined in a second mixer wherein they were mixed to form a homogenous liquid premixture. Thereafter metered amounts of the pulvurent premixture were concurrent supplied with metered amounts of the liquid premixture to the feed hopper of an extruder which was operated at a barrel temperature of 20° C.-40° C., wherein the extrudate exited the extruder via an exit die having a die orifice having a cross-sectional shape of an oblate equilateral triangle, approximately equal to the shape of the underside 12 of the shaped body 10 of FIG. 3. The extrudate was cut into shaped bodies having a volume of 8-12 cm³, and further had a generally planar face having a surface area of 17 cm² which face was adapted to be applied to the surface of a toilet bowl. The shaped body was then introduced into the blister part of the combination package and dispensing article, and a backing part was adhered to the margins of the blister part, thereby sealing the shaped body within the cavity.

TABLE 1

| | E1 |
|---|---|
| sodium alkylbenzene sulfonate | 25.0 |
| (80%) | |
| sodium alpha C₁₄₋₁₆sulfonate | 25.0 |
| (80%) | |
| amine oxide | 1.5 |
| polyvinylpyrrolidone (30%) | 0.3 |
| silicon dioxide | 1.5 |
| sodium bicarbonate | 1.01 |
| anhy. sodium sulfate | 39.3 |
| titanium dioxide | 0.08 |
| dye | 0.0086 |
| fragrance | 0.3 |

The identity of the constituents of Table 1 are disclosed on the following Table 2, the constituents were used “as supplied’ from their respective suppliers. As noted, unless otherwise indicated, the constituents were provided as “100% wt. actives”, but where a constituent included a lesser amount of “% wt. actives” such is identified on Table 1 and/or Table 2. E.g., where 0.3% wt. of polyvinylpyrrolidone (30%) is indicated, the actual % wt. of the polyvinylpyrrolidone present in the composition was (0.3×0.3=0.09% wt.)

TABLE 2

| | |
|---|---|
| sodium alkylbenzene sulfonate | C₁₀₋₁₆ benzene sulfonate, sodium salt (80% wt. |
| (80%) | actives) ex. Noblechem |
| sodium alpha C₁₄₋₁₆sulfonate | C₁₄₋₁₆ sulfonate, sodium salt (80% wt. actives) ex. |
| (80%) | Huntsman |
| amine oxide (30%) | C₁₀₋₁₆ amphoteric surfactant, approx. 230 molecular |
| | weight (30% wt. actives) |
| polyvinylpyrrolidone (30%) | polyvinylpyrrolidone with a molecular weight in the |
| | range of 240,000-450,000, 30% wt. actives, |
| | (balance, water) (ex. ISP Co.) |
| silicon dioxide | synthetic precipitated amorphous silica. (100% wt, |
| | actives) ex. Rhodia |
| sodium bicarbonate | anhydrous sodium bicarbonate, technical grade |
| | (99%-100% wt. actives) |
| anhy. sodium sulfate | anhydrous sodium sulfate, technical grade |
| | (97.5-100% wt. actives) |
| titanium dioxide | anhydrous titanium dioxide (100% wt. actives) |
| dye | proprietary composition of its supplier, ex. Clariant |
| fragrance | proprietary composition of its supplier, ex. Givaudan |

### Performance Testing:

Individual replicates of the shaped body (shaped blocks) formed from the composition of Ex. 1 were formed into shaped bodies, each replicate having a volume of about 11 cm³, and further having a generally planar face having a surface area of 17 cm² which face was adapted to be applied to the surface of a toilet bowl. Individual replicates were then applied to the sidewall of a either a model “Incepa” 6 liter toilet bowl or an “Incasa” 6 liter toilet bowl (both, ex. Brazil Standard Brands) each of which was operated to flush 16 hours a day at 90 minute intervals. The individual shaped bodies were positioned at different locations in the toilet bowl, e.g, which were generally approximately oriented as a clock face's placement of the “hours” thereon. In this orientation the “12 o'clock” position corresponded to the part of the toilet bowl nearest to the cistern or tank, and the “6 o'clock” position corresponded to that part of the toilet bowl furthest from the cistern or tank. As the initial mass of each of the replicate shaped blocks was known prior to the test, and the number of flushes which occurred till the entire shaped body of the lavatory treatment composition was consumed was also observed and noted in the test, the average mass of the lavatory treatment composition consumed in each flush due to the contact with the flush water was also determined. The position of each of the individual shaped replicates in the indicated model of toilet bowls, the number of flushes required to consume each block, and the calculated rate of consumption per flush is noted on the following Table 3.

TABLE 3

| | | | number of | Calculated consumption |
|---|---|---|---|---|
| sample | toilet | | flushes till | rate per flush |
| (block) | model | position | consumed | (grams per flush) |
| 1 | Icasa | 3 o'clock | 256 | 0.5441 |
| 2 | Icasa | 4 o'clock | 352 | 0.0396 |
| 3 | Icasa | 6 o'clock | 432 | 0.0326 |
| 4 | Icasa | 8 o'clock | 384 | 0.0354 |
| 5 | Icasa | 9 o'clock | 544 | 0.0259 |
| 6 | Incepa | | 496 | 0.0269 |
| 7 | Incepa | | 496 | 0.0284 |
| 8 | Incepa | | 480 | 0.0346 |
| 9 | Incepa | | 400 | 0.0353 |
| 10 | Incepa | 448 | 448 | 0.0309 |

As is seen from the foregoing, each replicates of the shaped bodies of the formed from the composition of Ex. 1 provided a long service life and provided a good treatment benefit to the toilet bowl.

1. A combination package and dispensing article comprising an adhesive lavatory treatment composition which is adherable to a part of a lavatory appliance, wherein the combination package and dispensing article includes:
a body of an adhesive lavatory treatment composition having at least one generally planar side which adapts the body to be adhered to a generally flat or curved sidewall of the lavatory appliance,
a separable backing part,
and a blister having a body cavity,
a domed or curved sidewall,
a mounting handle extending outwardly from the body cavity,
at least one edge standoff element, and
at least one body standoff element,
wherein the combination package and dispensing article is adapted to directly dispense the body onto the surface of a lavatory appliance without requiring that the consumer dispensing the said composition come into direct contact with the said composition during any part of the dispensing process.

2. A combination package and dispensing article according to claim 1, wherein the body of the adhesive lavatory treatment composition is in the shape of an oblate equilateral triangle.

3. A combination package and dispensing article according to claim 1, wherein the body of the adhesive lavatory treatment composition comprises:
at least 35% wt. of one or more detersive anionic surfactants;
0.01-10% wt. of one or more detersive nonionic and/or amphoteric surfactants;
0.001-5% wt. of at least one polyvinylpyrrolidone polymer constituent as an adhesion promoter constituent;
at least 35% wt. of one or more inert filler materials;
0-5% wt. added water; and,
optionally, one or more further constituents which may impart a further aesthetic or technical benefit to the said self-adhesive lavatory treatment compositions.

4. A method of treating a lavatory appliance utilizing an adhesive lavatory treatment composition which is dispensed directly from a combination package and dispensing article according to claim 1, the method comprising the steps of:
directly adhering the body of adhesive lavatory treatment composition to a part of the lavatory appliance wherein the position of the adhered body is in the path of flowing water, and subsequently,
contacting the adhered body with water, thereby to form a lavatory treatment liquid which treats the lavatory appliance.

5. A method of manufacturing a combination package and dispensing article comprising an adhesive lavatory treatment composition according to claim 1, which method comprises the steps of:
forming a body of an adhesive lavatory treatment composition which body has at least one generally planar side;
forming a combination package and dispensing article having a blister having a body cavity, a domed or curved sidewall, a mounting handle extending outwardly from the body cavity, at least one edge standoff element, and at least one body standoff element,
providing the body into the body cavity, and thereafter
applying a separable backing part to a part of the blister.
